(19) United States
(12) Patent Application Publication
(10) Pub. No.: US 2009/0181233 A1
(43) Pub. Date: Jul. 16, 2009

(54) COMPOSITE MATERIAL FOR SOFT AND DURABLE COMPONENT PARTS

(75) Inventor: Robert E. Sterling, Colbert, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: EXHAUST TECHNOLOGIES, INC., Spokane, WA (US)

(21) Appl. No.: 12/127,708

(22) Filed: May 27, 2008

Related U.S. Application Data
(60) Provisional application No. 61/020,997, filed on Jan. 14, 2008.

(51) Int. Cl. B32B 5/02; B32B 27/34; B29C 45/00; B32B 27/02

(52) U.S. Cl. 428/297.4; 264/328.14

(57) ABSTRACT

An injectable composite material made from a nylon and a para-aramid pulp, methods of manufacturing the injectable composite material, and components useful in tools and air motors made using the injectable composite material.

### CROSS-REFERENCE TO RELATED APPLICATION

This application claims the benefit of U.S. Provisional Application No. 61/020,997, filed Jan. 14, 2008, expressly incorporated herein by reference in its entirety.

### BACKGROUND OF THE INVENTION

Power hand tools, for example pneumatic hand tools, are used in factories, repair shops, home workshops and garages, and outdoors on work decks and curb sides in the United States and throughout the world. Such tools have found great adoption and acceptance, increasing efficiency, simplifying jobs and enabling workers to accomplish tasks quickly that would otherwise be difficult or impractical.

Power hand tools typically comprise a tool body that is adapted to lockingly receive a number of different attachments and tools, for example in a chuck mechanism, and a power system contained within the body for driving the tool. An external power source such as pressurized air, or an internal power source such as batteries, provide the energy for the power system.

Although power hand tools generally reduce the work required to complete a given task, it will be appreciated that such hand tools, with attachment, power supply and the like, can be quite heavy. Heavy tools can cause undue fatigue to a user that may be using the hand tool for long periods of time.

It will also be appreciated that such hand tools typically must endure very demanding environments and operating conditions. The tool itself, of course, typically generates significant pounding and vibrations, as any user of a pneumatic driver knows. In addition, such tools are typically used over concrete floors or outdoors, and may be frequently dropped or roughly set down many times during a day of use. Additionally, such tools are often transported frequently to different work sites, resulting in additional wear, tear and exposure to rough treatment. The factory, garage or workshop environment may also include chemically caustic substances and/or solvents that the tools may be regularly subjected to. Finally, power hand tools are often used in outdoor activities such as construction or automobile repair, and subjected to the vagaries of the weather, for example cold weather, direct sunlight, rain and the like.

It would be beneficial, therefore, to reduce the weight of power hand tools, and to ruggedize such tools to reduce the risk of damage and increase durability.

Similarly, particular components of air motors (e.g., rotor vanes) would benefit from a soft, flexible, lightweight material that is also durable in order to alleviate the issue of material failure. Air motor rotor vanes are particularly susceptible to failure when manufactured with traditional materials (e.g., nylon). Rotor vanes are an essential part of air motors and must be made of a soft material that allows the vane to make sealed contact with the motor casing so as to maximize capture of the air passed through the motor. Because the vanes must be soft in order to make sealing contact with the casing they are susceptible to material failure. Hardening the vane material to increase durability typically decreases performance (i.e., air-capturing ability). Also, because traditional vanes are soft they suffer from failure faster than other parts of the air motor, thus leading to frequent replacement. A more robust material that remains soft enough to perform like traditional vane materials and can be manufactured into an air motor rotor vane would be beneficial in allowing air motors to operate for longer before replacement, and all of the attendant benefits that would arise from such performance (e.g., time and money saved).

### SUMMARY OF THE INVENTION

Pneumatic hand tool component are provided. The components are made from an injectable composite material comprising a nylon and a para-aramid pulp comprising para-aramid fibers having a length not greater than 1 mm. The components are lighter in weight and more durable than similar components made from traditional materials, such as nylon.

Additionally, methods for making tool components are provided. The method of manufacturing includes heating a nylon to a first temperature; heating a para-aramid pulp to a second temperature; mixing a first portion of the heated para-aramid pulp into the heated nylon to provide a first mixture; mixing a second portion of the heated para-aramid pulp into the first mixture to provide a second mixture; and injection molding the second mixture into a mold to provide a pneumatic hand tool component.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a perspective view of a pneumatic hand tool having an outer body fabricated primarily from an injectable composite material made in accordance with the present invention;

FIG. 2 is a flow chart illustrating a representative method for making injectable composite materials in accordance with the present invention; and

FIG. 3 shows an exploded view of a portion of an air motor having rotor vanes made using an injectable composite material made in accordance with the present invention.

### DETAILED DESCRIPTION OF THE INVENTION

The invention provides injectable composite materials of a nylon and a para-aramid pulp, methods for making the injectable composite materials, and components of tools and air motors made from the injectable composite materials. The injectable composite material provides unusually light and rugged properties when incorporated as interior or exterior components of tools and air motors and is particularly useful as a component of pneumatic air tools and air motors.

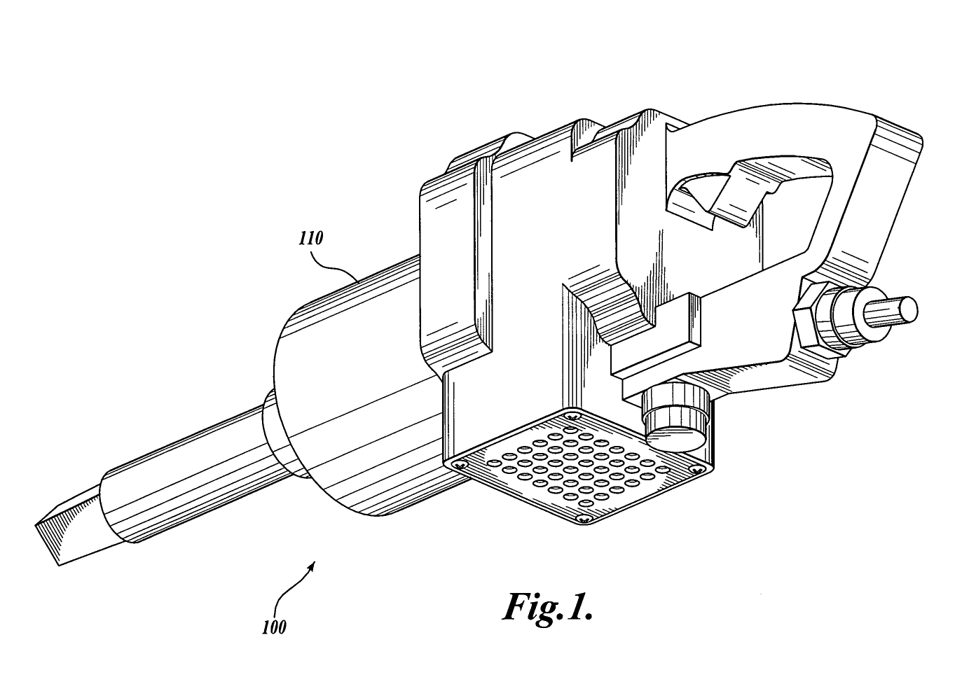

In an exemplary use of the injectable composite material, referring to FIG. 1, the injectable composite material for the outer body 110 of a tool 100 is formed from a mixture of a para-aramid pulp and a nylon.

Para-aramid pulp is useful as an additive that is both strong and lightweight. Because injection molding is a preferred method for forming the composites, para-aramid fibers in pulp form (e.g., fiber lengths below about 1 mm) are particularly preferred. A preferred para-aramid pulp is a para-aramid synthetic pulp marketed under the brand name Kevlar®.

Nylon is a polymer with repeating amide groups —[NH—CO]—. In particular, in the currently preferred composite material nylon 6,6 (also known as nylon 66), which may be produced by condensation reaction of adipic acid and hexamethylenediamine to give the —[NH—(CH₂)₆—NH—CO(CH₂)₄—CO]— repeating unit, is used. Other representative nylons include nylon 6 and nylon 12.

A mixture of para-aramid pulp and nylon forms a lightweight and unusually durable composite that can be injection molded. A currently preferred mixture or formula comprises approximately 30% para-aramid pulp by volume and approximately 70% nylon by volume. An exemplary embodiment of the composite material is described in Example 1. It will be readily apparent to persons of skill in the art that these ratios may be modified without departing from the present invention. For example, it is contemplated that the para-aramid pulp may range from 20%-50% by volume of the composite material, and the nylon may range from 50%-80% by volume of the composite material. Above a concentration of about 50% by volume of the para-aramid pulp, the composite material lacks enough binder (nylon) to provide the structural support for the para-aramid pulp. The resulting composite material will crumble and is not suitable for injection molding. Below concentrations of about 20% by volume of the para-aramid pulp, the durability of the composite material is not enhanced to a sufficient extent so as to provide the benefits described herein (e.g., highly durable air motor rotors).

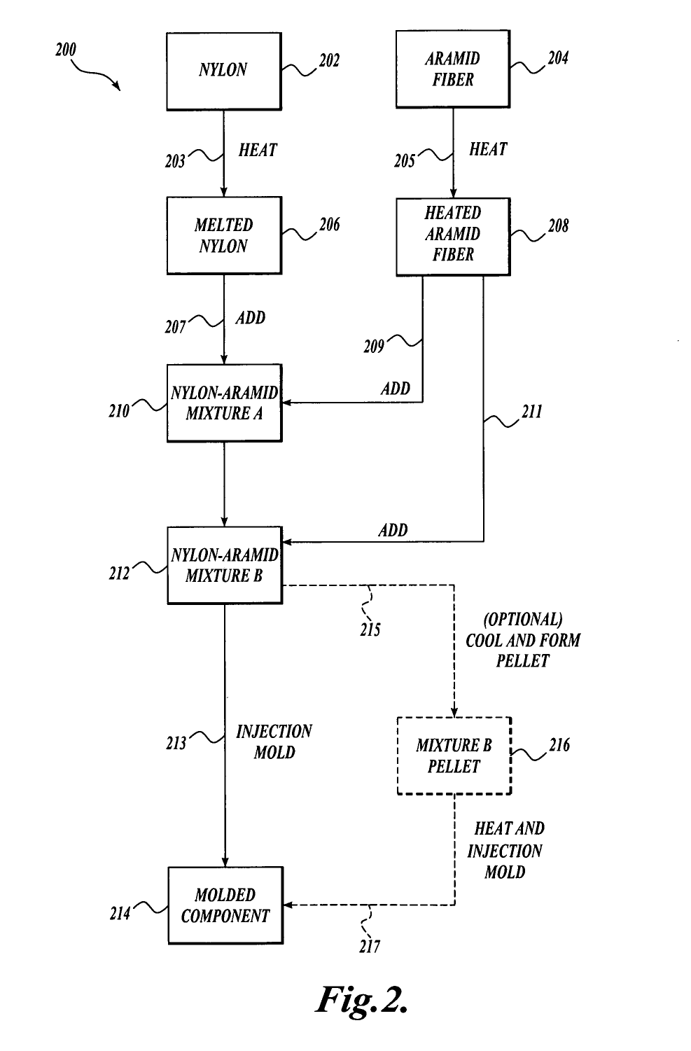

Referring now to FIG. 2, a representative manufacturing process 200 is illustrated. Nylon 202 is heated 203 to produce melted nylon 206. Similarly, aramid pulp 204 is heated 205 to produce heated aramid pulp 208. The melted nylon 206 is added 207 and heated aramid pulp 208 is added 209 to form mixture A 210. Because it is typically difficult to incorporate the heated aramid pulp 208 into the melted nylon 206, the mixing can occur in two or more stages to reach a concentration of aramid pulp 204 in the final composite material that will provide the desired physical characteristics. Typically, a second portion of heated aramid pulp 208 is added 211 to mixture A 210 to form mixture B 212. Mixture B 212 contains melted nylon 206 and heated aramid pulp 208 and can be directly injection molded 213 to form a molded component 214. Optionally, mixture B 212 can be cooled and formed 215 into a pellet 216 that can be stored until needed, then heated and injection molded 217 to form molded component 214.

The nylon is heated until melted. In a representative example, nylon 6,6 is heated to about 260° C. and Kevlar® pulp is preheated to about 290° C. to avoid gelling upon incorporation with the nylon. Approximately half of the Kevlar® pulp to be added (15% of the final volume of the composite mixture in this representative example) is mixed with the nylon 6,6 to produce a mixture comprising approximately 15% Kevlar® pulp by volume. The remainder of the preheated Kevlar® pulp is then added and mixed, to produce a final mixture comprising approximately 30% Kevlar® pulp. The temperatures that the nylon and the aramid pulp are heated to are determined by the melting temperature of the nylon. The melting temperature of the nylon depends on the particular nylon selected (e.g., nylon 6,6 or nylon 6) or blends of nylons.

It will be appreciated that the composite material may comprise additional components, as described in Example 2. Representative additional components include materials that provide coloring, texture, or further enhance the durability of the composite material. In another embodiment, the composite material comprises approximately 25% para-aramid pulp by volume, approximately 70% nylon by volume, and approximately 5% ground fiberglass by volume. It will be readily apparent to persons of skill in the art that these ratios may be modified without departing from the present invention.

The composite materials may also include mixtures of nylons and/or para-aramid pulps. In one embodiment, the composite material includes nylon 6,6; nylon 6; and para-aramid pulp.

In a preferred method, the mixture is drawn out and cooled to produce pellets of material approximately 2 mm in diameter, and 4 mm in length. The pellets may then be provided to an injection mold apparatus. Preferably, the pellets are heated to about 280° C. prior to injection into a mold, then cooled, to produce the tool body 110, for example.

The currently preferred temperatures and dimensions identified above are intended to provide the artisan with a complete description of the inventor's currently preferred embodiment of the material and method, and are not intended to imply a limitation to the present method. In particular, it is anticipated that the temperatures may advantageously be modified if the ratio of para-aramid pulp and nylon are different, or if additional materials are added to the mixture.

The composite material disclosed herein has been found to be suitable for use, for example, in pneumatic hand tool housings, providing a strong, flexible, and durable material that retains these properties even in cold weather. For example, the nylon 6,6/para-aramid composite material provides weight saving advantages, reducing the total weight of an exemplary ½-inch drive pneumatic tool by 46 grams compared to traditional plastic materials, while increasing durability.

The composite material is also useful in internal and external components of air motors, including rotor vanes, levers, buttons, clutches, and motor housings. Air motor components, and particularly air motor rotor vanes, require materials that are both durable and soft. Because of the unique properties of the composite materials, they are ideal for forming air motor components, particularly rotor vanes. An air motor rotor vane made from the composite material is lighter and more robust than one made with traditional materials (e.g., nylon). When integrated into air motors, rotor vanes made using the composite material produce motors that are as efficient as motors made using nylon rotor vanes, but vanes made with the composite material are more robust and have a longer lifetime before needing replacement. It will be appreciate that any air motor component known to those of skill in the art as being traditionally made using nylon can be made using the composite material.

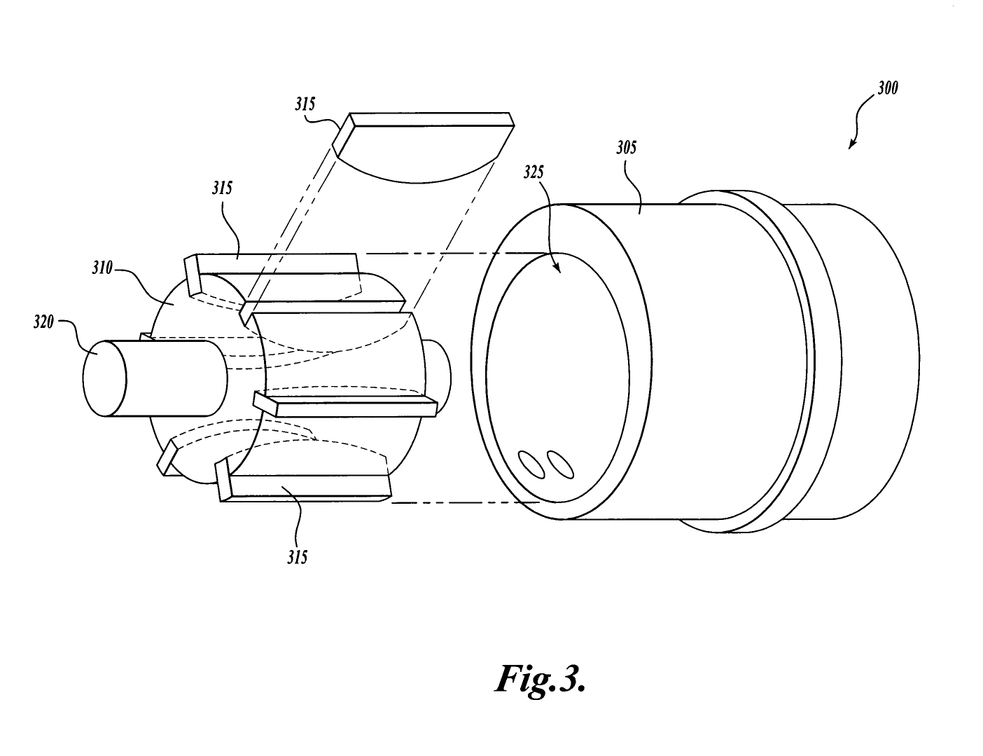

The operation of air motors is described in U.S. Pat. No. 3,642,389, incorporated herein in its entirety, and is well know to those of skill in the art. The advantages of integrating the composite material into an air motor as an air motor rotor vane can be better understood with reference to FIG. 3, an exploded view of a portion of an air motor 300 as used in a pneumatic tool. The portion of an air motor 300 includes a cylinder 305 for housing a rotor 310 having slidably connected rotor vanes 315. Upon interacting with pressurized air moved through the motor, the rotor vanes 315 force the rotation of the rotor 310, which in turn rotates a shaft 320 that is operatively connected to a tool head (not shown) at the terminal end of the tool (e.g., impact wrench).

When the air motor is operated, the rotor vane 315 forms a partial seal with the inner surface 325 of the cylinder 305, so as to capture the pressurized air flowing through the air motor. The partial seal is maintained by a force applied to the rotor vane 315 directed radially outward from the rotor 310 (e.g., by a spring or as a result of centripetal force). The rotating rotor vane 315 generates friction against the inner surface 325 and, thus, the rotor vane 315 is particularly susceptible to material failure due to the stress created by friction. A rotor vane 315 made from the composite will have a longer life, before mechanical failure as a result of friction with the inner surface 325, than a rotor vane 315 made from nylon or other traditional rotor vane materials.

The following examples are provided for the purpose of illustrating, not limiting, the invention.

### EXAMPLE 1

### Composite Material Made from a Nylon and a Para-Aramid Pulp

In this example, the composite material is mixed from 0.7 m³ of nylon 6,6 and 0.3 m³ of Kevlar® brand para-aramid pulp. The resulting mixture is 1 m³ of the composite material. That is, in this example, the composite material is 70% by volume nylon 6,6 and 30% by volume para-aramid pulp.

### EXAMPLE 2

### Composite Material Made from a Nylon, Fiberglass, and a Para-Aramid

In this example, the composite material is mixed from 0.7 m³ of nylon 6,6; 0.05 m³ of ground fiberglass; and 0.25 m³ of Kevlar® brand para-aramid pulp. The resulting mixture is 1 m³ of the composite material. That is, in this example, the composite material is 70% by volume nylon 6,6; 5% by volume ground fiberglass; and 25% by volume para-aramid pulp.

While the preferred embodiment of the invention has been illustrated and described, it will be appreciated that various changes can be made therein without departing from the spirit and scope of the invention.

1. An air motor component comprising a rotor vane made from an injectable composite material comprising a nylon and a para-aramid pulp comprising para-aramid fibers, substantially all of the para-aramid fibers having a length not greater than 1 mm.

2-3. (canceled)

4. The air motor component of claim 1, wherein the para-aramid fiber comprises between 20% and 50% by volume of the composite material.

5. The air motor component of claim 1, wherein the para-aramid pulp comprises about 30% by volume of the material and the nylon comprises about 70% by volume of the material.

6. The air motor component of claim 1, further comprising ground fiberglass.

7. The air motor component of claim 6, wherein the para-aramid pulp comprises about 25% by volume of the material, the nylon comprises about 70% by volume of the material, and the ground fiberglass comprises about 5% by volume of the material.

8. The air motor component of claim 1, wherein the nylon is nylon 6,6.

9. An air motor comprising a rotor vane made from an injectable composite material comprising a nylon and a para-aramid pulp comprising para-aramid fibers, substantially all of the para-aramid fibers having a length not greater than 1 mm.

10-11. (canceled)
